(19) United States
(12) Patent Application Publication
(10) Pub. No.: US 2016/0097129 A1
(43) Pub. Date: Apr. 7, 2016

(54) METHOD FOR FABRICATING METAL AND OXIDE HYBRID-COATED NANOCARBON

(71) Applicant: Donghee Holdings Co., Ltd., Ulsan (KR)

(72) Inventors: Seung-Il JUNG, Gyeonggi-do (KR); Joo-Ho CHA, Gyeonggi-do (KR); Jae-Deuk KIM, Gyeonggi-do (KR)

(21) Appl. No.: 14/593,654

(22) Filed: Jan. 9, 2015

(30) Foreign Application Priority Data
Oct. 7, 2014 (KR) 10-2014-0135170

(51) Int. Cl. C23C 18/16; C22F 1/08; C23C 18/34; C22C 32/00; C09C 1/44; C23C 18/40

(52) U.S. Cl. CPC C23C 18/1639; C09C 1/44; C23C 18/40; C23C 18/34; C23C 18/165; C23C 18/1692; C23C 18/1675; C22C 32/0021; C22F 1/08; C01P 2004/04; C01P 2004/80; C01P 2004/13; Y10S 977/847; Y10S 977/748; B82Y 40/00

(57) ABSTRACT

Disclosed herein is a method for fabricating metal and oxide hybrid-coated nanocarbon, comprising: a) coating nanocarbon with an oxide to give oxide-coated nanocarbon; b) coating the oxide-coated nanocarbon with a metal by electroless plating to give metal and oxide hybrid-coated nanocarbon; and c) crystallizing the metal and oxide hybrid-coated nanocarbon through thermal treatment at a high temperature. Also, the metal and oxide hybrid-coated nanocarbon fabricated using the method is provided.

### CROSS REFERENCE TO RELATED APPLICATION(S)

This application claims the benefit of Korean Patent Application No. 10-2014-0135170, filed Oct. 7, 2014, which is hereby incorporated by reference in its entirety into this application.

### BACKGROUND OF THE INVENTION

1. Technical Field

The present invention relates to a method for fabricating metal and oxide hybrid-coated nanocarbon.

2. Description of the Related Art

Currently, active studies on the application of nanocarbon as a reinforcement of aluminum are in progress. Nanocarbon is a nano-material that exhibits excellent physical and electrical properties as exemplified by having 100-fold greater mechanical strength than iron, 1,000-fold greater electrical conductivity than copper, and several fold greater thermal conductivity than graphite. However, nanocarbon cannot strongly bind to aluminum because it has a graphite structure and a density of 2 g/cm3 or less. Further, like water and oil, nanocarbon and aluminum are not immiscible with each other because of the great difference in their surface tension, which is approximately 20 times different therebetween. For these reasons, it is impossible to directly dissolve carbon nanotubes in aluminum.

C. L. Xu et al. (C. L. Xu, B. Q. Wei, R. Z. Ma, J. Liang, X. K. Ma, D. H. Wu, Carbon 37, 855˜858, 1999) discloses the fabrication of carbon nantotube-reinforced Al metal composites having high strength and high electric conductivity by mixing aluminum powder and carbon nanotube powder and sintering the mixture through hot pressing.

In this fabrication method, nanocarbon and matrix powders are simply mixed by which it is difficult to bring about an improvement in properties. In other words, simply mixing at a powder level cannot eliminate factors that have influences on properties of the composites, such as high porosity in microstructures, reinforcement aggregates, etc. These results are reflected by the overwhelming tendency of the nanocarbon-reinforced composite field towards direct production from raw materials. In addition, the results occur due to the fact that during the mixing and sintering procedure, the nanocarbon surrounds diffusion paths in the matrix, interfering with deposition at high density

As mentioned above, the conventional method of mixing nanocarbon and aluminum is no more than simple mechanical mixing of aluminum and nanocarbon using an apparatus, such as, ball mill. This mechanical mixing is prone to oxidizing metal, with the concomitant destruction of CNT.

In addition, when nanocarbon and aluminum are simply mixed, the mixture is difficult to mold by die casting because a great difference in density therebetween.

To overcome this problem, Korean Patent No. 10-1123893 suggests the fabrication of carbon nanotube-aluminum composites using carbon nanotube-copper composites.

Because it comprises sintering a mixture of a carbon nanotube-copper composite and aluminum, however, this fabrication method suffers from the disadvantage of being high in production cost and having difficulty in manufacturing a carbon nanotube-aluminum composite having a large display area.

Accordingly, the present inventor suggests a method for improving nanocarbon in terms of wettability and thermal resistance, whereby the nanocarbon can be used in an nanocarbon-aluminum cast alloy.

### SUMMARY OF THE INVENTION

The present invention aims to provide a method for improving nanocarbon in terms of wettability and thermal resistance, whereby the nanocarbon can be used as a reinforcement of aluminum.

In order to solve the problems encountered in conventional techniques, the present invention provides a method for fabricating metal and oxide hybrid-coated nanocarbon, comprising: a) coating nanocarbon with an oxide to give oxide-coated nanocarbon; b) coating the oxide-coated nanocarbon with a metal by electroless plating to give metal and oxide hybrid-coated nanocarbon; and c) crystallizing the metal and oxide hybrid-coated nanocarbon through thermal treatment at a high temperature.

Also, the present invention provides a metal and oxide hybrid-coated nanocarbon, fabricated using the method of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows TEM data of CNT coated with TiO₂ in an O₂ atmosphere upon thermal treatment at various temperatures in accordance with an embodiment of the present invention;

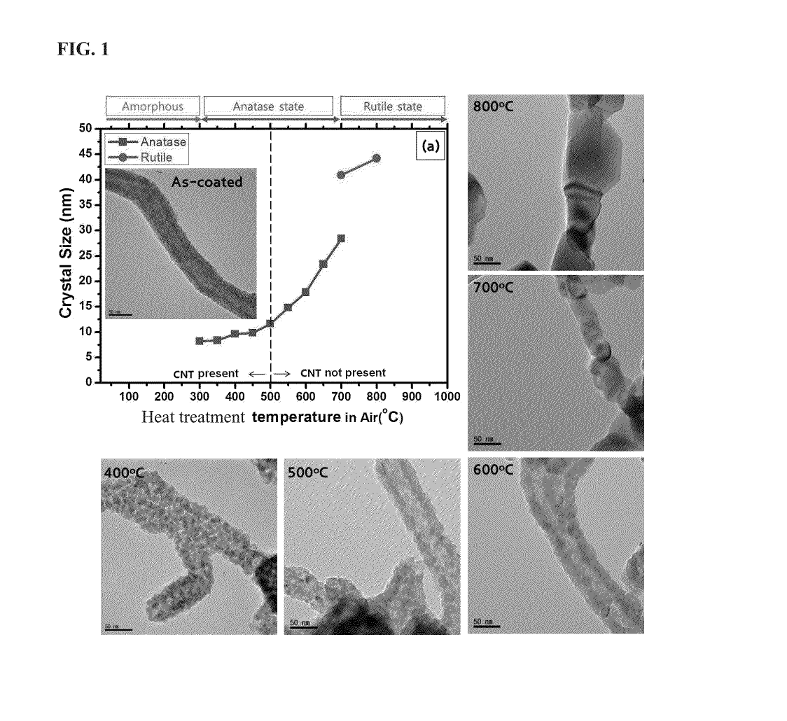

FIG. 2 shows TEM data of CNT coated with TiO₂ in an Ar atmosphere upon thermal treatment at various temperatures in accordance with an embodiment of the present invention;

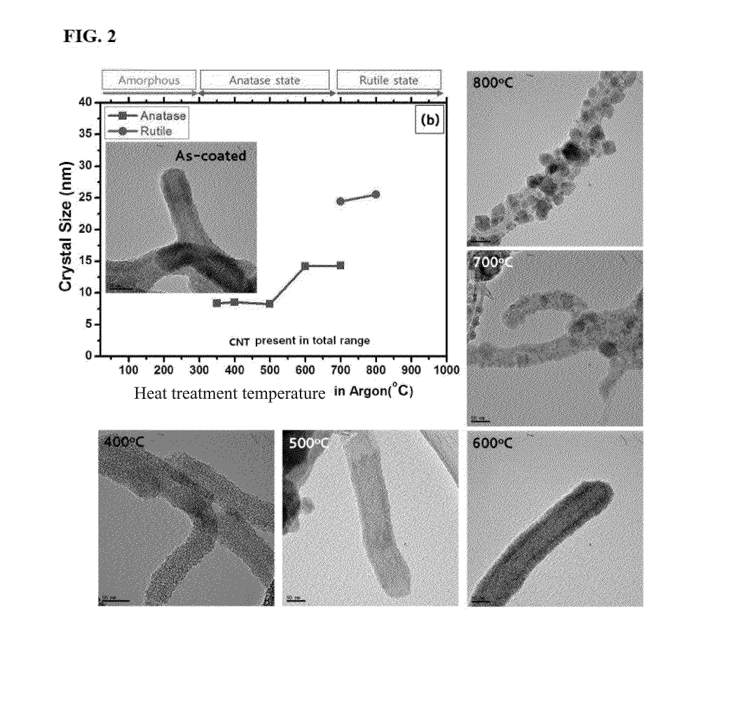

FIG. 3 shows TEM images and an EDS spectrum of TiO₂-coated CNT with various phases and grain sizes on which a fibrous Ni—P coating layer is deposited in accordance with an embodiment of the present invention;

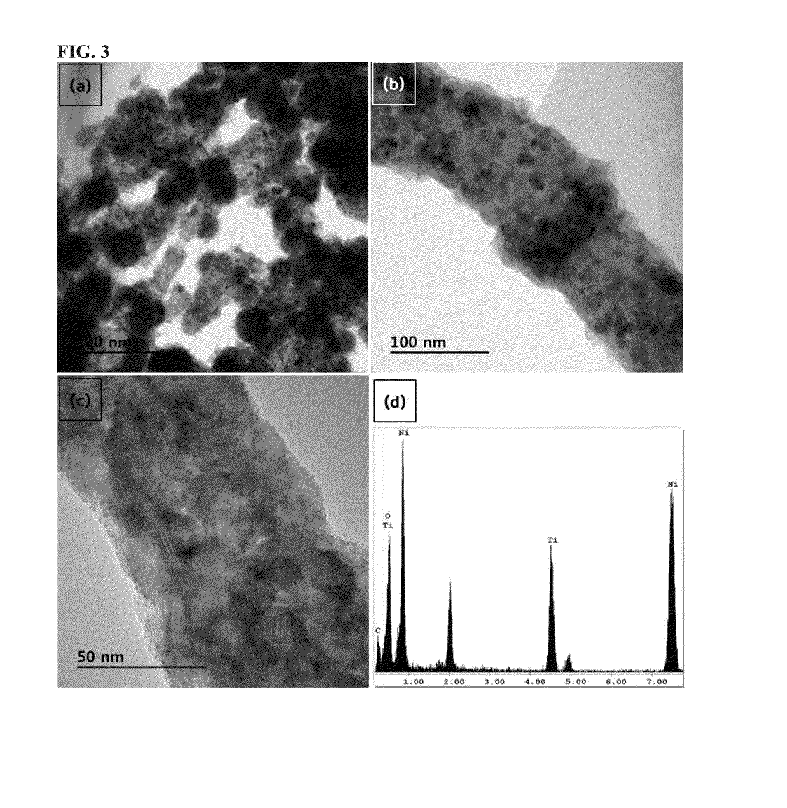

FIG. 4 shows TEM images and an EDS spectrum of TiO₂-coated CNT with various phases and grain sizes on which a scale-like Ni—P coating layer is deposited in accordance with an embodiment of the present invention;

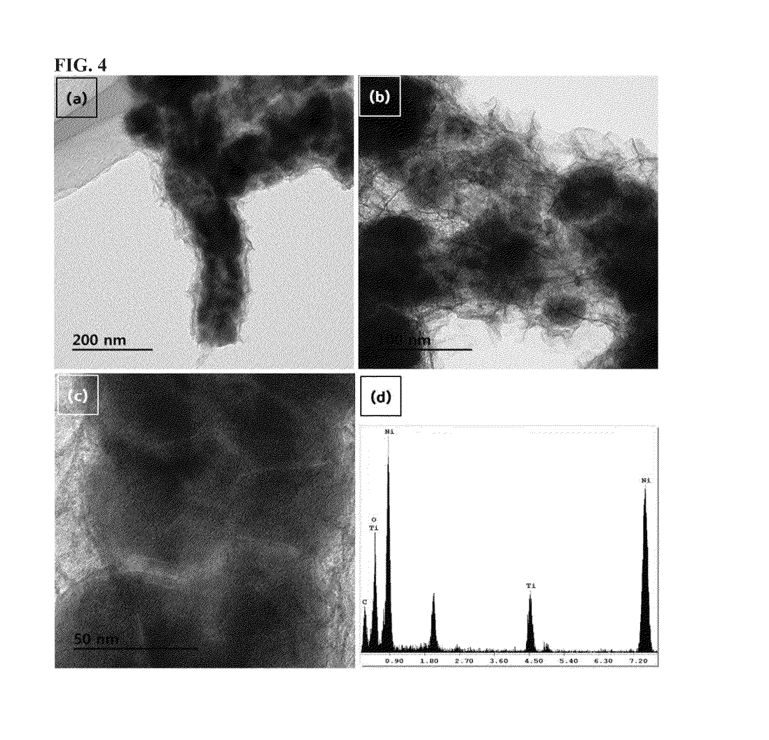

FIG. 5 shows TEM images and an EDS spectrum of TiO₂-coated CNT with various phases and grain sizes on which a spherical Ni—P coating layer is deposited in accordance with an embodiment of the present invention;

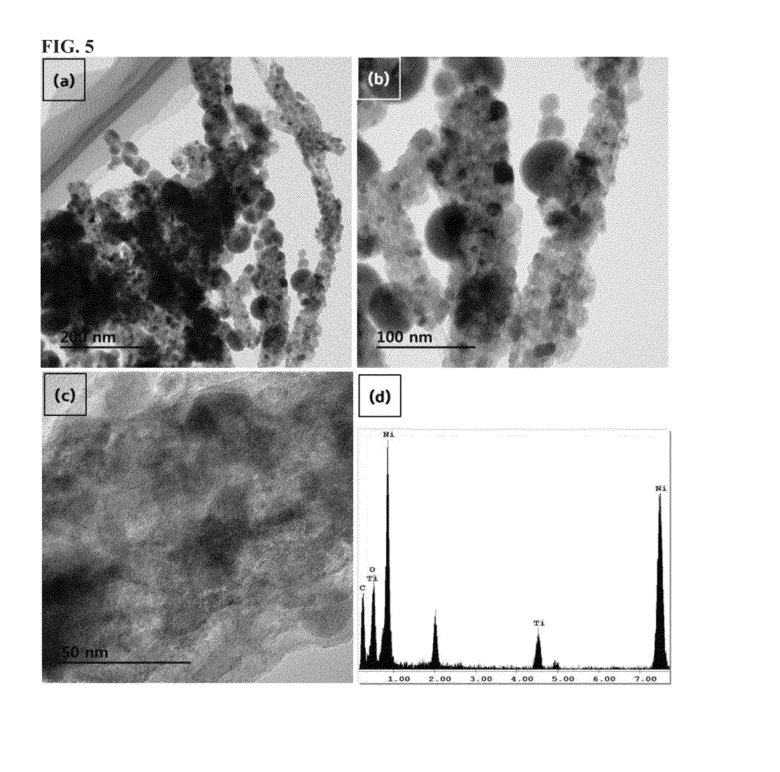

FIG. 6 shows TEM images and an EDS spectrum of TiO₂-coated CNT with various phases and grain sizes on which a fibrous Cu coating layer is deposited in accordance with an embodiment of the present invention;

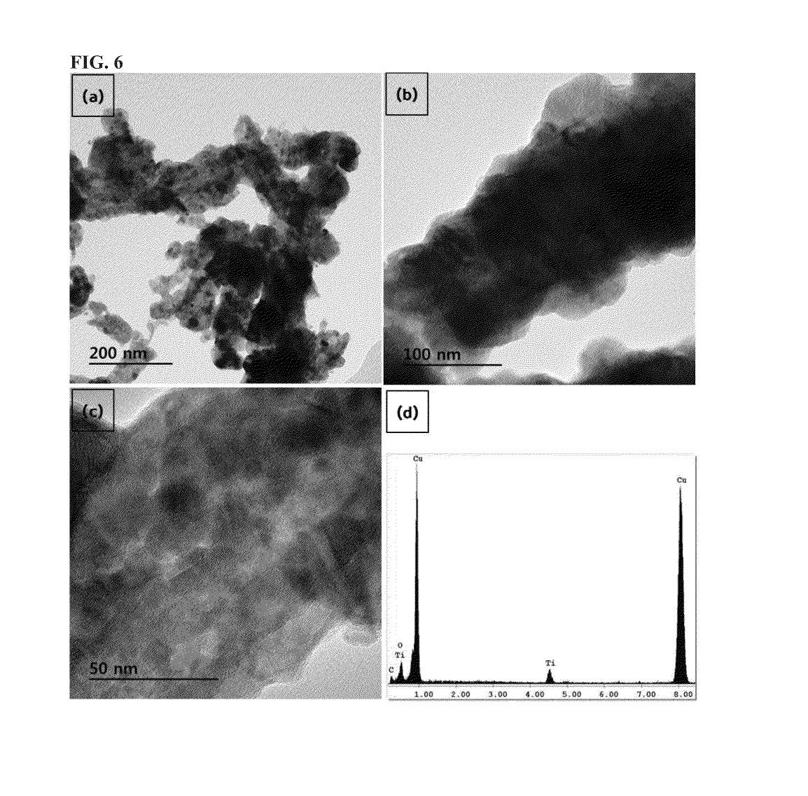

FIG. 7 shows TEM images and an EDS spectrum of TiO₂-coated CNT with various phases and grain sizes on which a scale-like Cu coating layer is deposited in accordance with an embodiment of the present invention; and

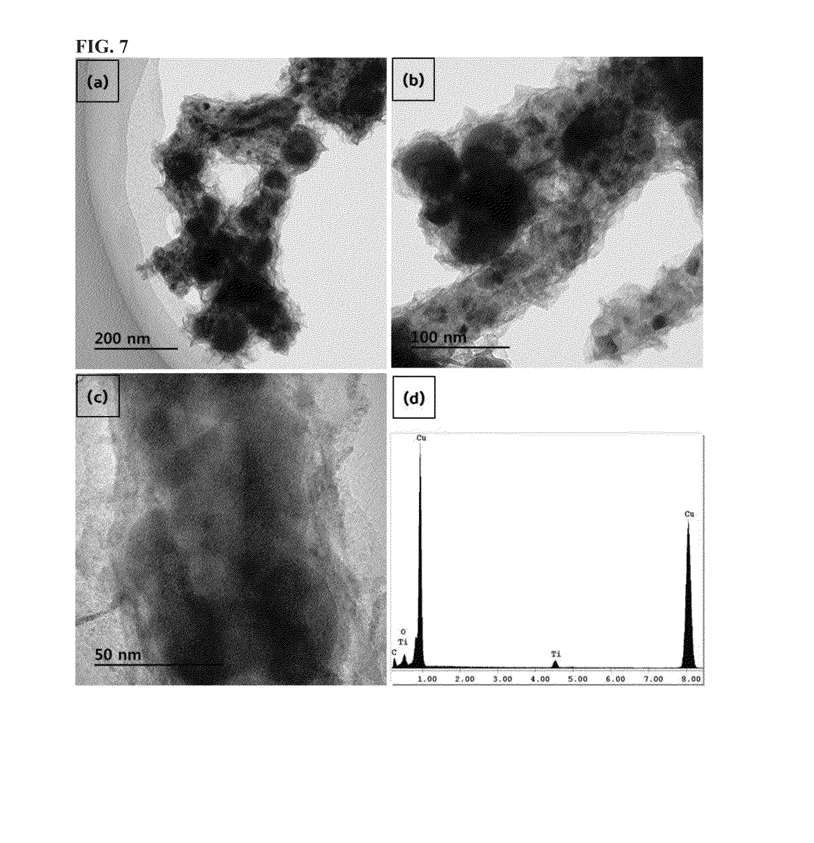

FIG. 8 shows TEM images and an EDS spectrum of TiO₂-coated CNT with various phases and grain sizes on which a spherical Cu coating layer is deposited in accordance with an embodiment of the present invention.

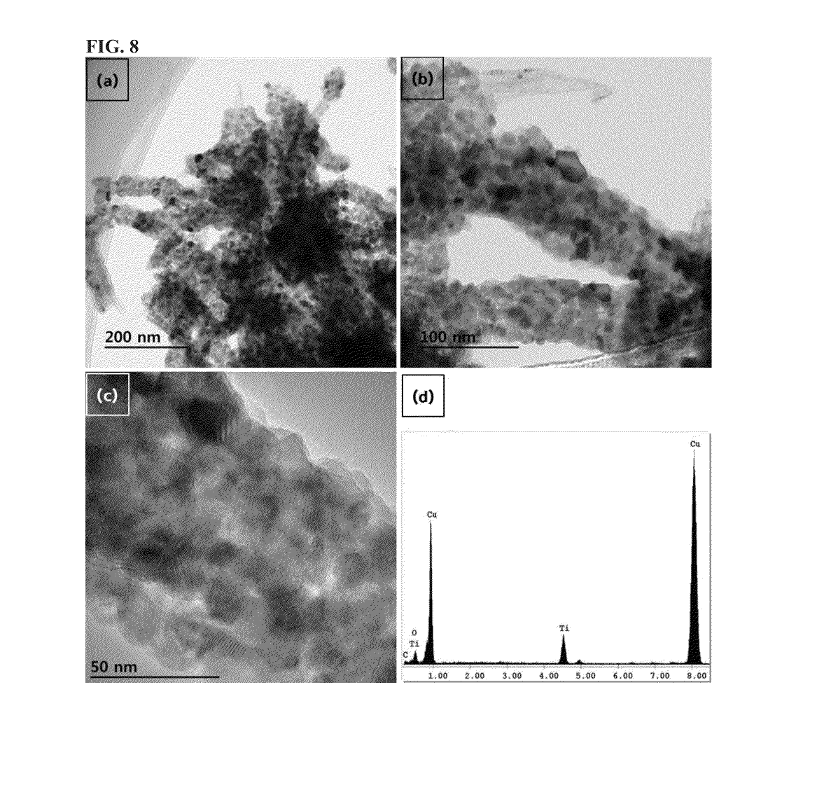

### DESCRIPTION OF THE PREFERRED EMBODIMENTS

Below, a detailed description will be given of the present invention.

The present invention addresses a method for fabricating metal and oxide hybrid-coated nanocarbon, comprising: a) coating nanocarbon with an oxide to give oxide-coated nanocarbon; b) coating the oxide-coated nanocarbon with a metal by electroless plating to give metal and oxide hybrid-coated nanocarbon; and c) crystallizing the metal and oxide hybrid-coated nanocarbon through thermal treatment at a high temperature.

In step a), nanocarbon is coated with an oxide to prepare oxide-coated nanocarbon.

The nanocarbon useful in step a) may be divided into metallic nanocarbon such as CNF (Carbon nano fiber), MWCNT (multi wall carbon nanotube), TWCNT (Thin wall carbon nanotube), DWCNT (double wall carbon nanotube) and metallic SWCNT (single wall nanotube), and semiconducting nanocarbon such as semiconducting SWCNT and SWCNT bundles.

TiO₂, SiO₂, and Al₂O₃ may fall within the scope of the oxide applicable to nanocarbon in step a).

In step a), a sol-gel process may be used to coat nanocarbon with an oxide.

In the present invention, nanocarbon can be coated with an oxide simply and non-destructively using a sol-gel process.

According to one embodiment of the present invention, a sol-gel process is used to coat nanocarbon with TiO₂.

For use in the sol-gel process, titanium (IV) n-butoxide (TNBT), titanium (IV) isopropoxide (TIP), titanium (IV) propoxide (TPP), tetrabutyl orthotitanate (TBOT), or other titanium alkoxides in an organic solvent may be used as a Ti precursor.

In one embodiment of the present invention, the Ti precursor may be used in an amount 1˜30 times the weight of nanocarbon.

Acting as a coupling agent, benzyl alcohol may be employed in the sol-gel process. In one embodiment of the present invention, the coupling agent may be used in an amount 1˜50 times the weight of the nanocarbon.

An organic/inorganic solvent may be used. Examples of the organic solvent include methanol, ethanol, butanol, chloroform, 1,2-dichloroethane (DCE), ethyl acetate, hexane, diethylether, acetonitrile, benzene, tetrahydrofuran (THF), dimethyl formamide (DMF), and 1-methyl-2-pyrrolidinone (NMP). In one embodiment of the present invention, the organic solvent may be used in an amount 1˜200 times the weight of the nanocarbon. For an inorganic solvent, deionized water may be used. In one embodiment of the present invention, an inorganic solvent may be used 1˜50 times the weight of the nanocarbon.

A reaction temperature for this step may be preferably set to be 0° C. or lower.

The step may be carried out in an inert gas atmosphere (Ar, N₂, He, etc.) or in a vacuum (10⁻³˜10⁻² torr).

Once coated with an oxide, the nanocarbon improves in thermal resistance.

In the present invention, nanocarbon is used at a volume ratio of 1:1˜1:20 with an oxide.

In the present invention, nanocarbon is used at a weight ratio of 1:1˜1:50 with an oxide.

Preferably, the oxide coating may have a thickness of 5˜20 nm, and more preferably up to 10 nm in terms of production cost and in the aspect of improving the performance of an aluminum cast alloy of high volume fraction.

Prior to the step a), the method of the present invention may further comprise a1) washing in a solvent and thermally oxidizing nanocarbon to remove impurities therefrom.

The step a1) may be to remove impurities such as amorphous carbon by washing nanocarbon in an organic solvent or an aqueous acid solution.

Among the organic solvents used in this context are ethanol, acetone, 1,2-dichloroethane (DCE), tetrahydrofuran (THF), dimethyl formamide (DMF), and 1-methyl-2-pyrrolidinone (NMP).

In the step a1), ultrasonication may be employed in combination.

For instance, nanocarbon powder is immersed in an amount of 0.01˜1 wt % in an organic solvent such as alcohol or an aqueous acidic solution and then subjected to ultrasonication to remove impurities such as amorphous carbon.

Alternatively, the step a1) may be to remove impurities by thermally oxidizing nanocarbon at 300˜500° C. for 30 min to 5 hrs in air. Compared to the washing process with a solvent such as an alcohol, the thermal oxidation process has advantages in terms of economical and environmental aspects.

Optionally, the method of the present invention may further comprise a2) thermally treating the oxide-coated nanocarbon to remove impurities therefrom, with the concomitant crystalline phase conversion and size control of grains.

In one embodiment of the present invention, the step a2) is thermally treating the oxide-coated nanocarbon at 300˜800° C. for 30 min to 5 hrs in an O₂ atmosphere, an inert gas atmosphere (Ar, N₂, He, etc.) or in a vacuum (10⁻³˜10⁻² torr).

For example, thermal treatment at 300˜650° C. in an O₂ atmosphere forms TiO₂ in a 100% anatase phase, with a grain size of 5˜20 nm. Particularly, when the oxide-coated nanocarbon is treated at about 500° C. or higher in an O₂ atmosphere, only TiO₂ in a different phase exists while CNT is burnt up by oxidization. Oxidization temperatures vary depending on the type of CNT. Upon thermal treatment at a temperature of 650˜750° C., the oxide TiO₂ in a mixture of about 40% anatase phase and 60% rutile phase, with a grain size of 20˜40 nm, is formed in a nanowire form while CNT does not exist. At 800° C. or higher, the oxide TiO₂ in a 100% rutile phase with a grain size of 40 nm or greater appears in a nanowire form while CNT disappears.

In another embodiment, thermal treatment at 300˜650° C. in an inert gas (Ar, N₂, He, etc.) atmosphere forms the oxide TiO₂ in a 100% anatase phase with a grain size of 5˜15 nm while CNT coexists. CNT is not burnt up in an inert gas atmosphere, unlike in an O2 atmosphere. When treated at 650˜750° C., the oxide TiO₂ in a mixture of about 30% anatase phase and 70% rutile phase with a grain size of 15˜25 nm coexists with CNT. At 800° C. or higher, the oxide TiO₂ has a 100% rutile phase with a grain size of 25 nm or greater in the presence of CNT.

In step b), the oxide-coated nanocarbon is plated with a metal, such as nickel (Ni) or copper (Cu) using an electroless plating process.

For electroless nickel plating, a p-type reductant is used. Thus, the oxide-coated nanocarbon is plated with nickel-P.

Upon electroless nickel plating, step b) may comprise b1) immersing the oxide-coated nanocarbon in a Pd solution to form an active Pd nuclei on a surface of the oxide-coated nanocarbon; b2) treating the Pd-nucleated, oxide-coated nanocarbon with strong acid; and b3) depositing a nickel layer on the strong acid-treated, oxide-coated nanocarbon by electroless plating in a nickel solution.

Step b) includes step b1) in which the oxide-coated nanocarbon is immersed in a Pd-containing solution to reduce Pd ions on a surface of the oxide-coated nanocarbon, thus forming active Pd nuclei on the surface.

Step b1) allows the electroless plating of the subsequent step b3) to be performed only on the activated surface of the oxide-coated nanocarbon. The degree of activation of the nanocarbon surface has influences on the adhesion of the electroless coating layer.

When the nanocarbon is a semiconducting SWCNT or SWCNT bundle, the method may further comprise immersing the semiconducting nanocarbon in an Sn-containing solution to adsorb Sn²⁺ ions on a surface of the semiconducting nanocarbon, and washing the nanocarbon, that is, a sensitizing step.

For the nanocarbon of CNF, MWCNT, TWCNT, DWCNT or metallic SWCNT, no sensitization treatment is required whereas the semiconducting SWCNT or SWCNT bundle needs a sensitization treatment before activation.

Also, step b) includes step b2), characterized by accelerated treatment, in which the Pd-nucleated, oxide-coated nanocarbon is treated with strong acid to deposit pure Pd when the nanocarbon is metallic (CNF, MWCNT, TWCNT, DWCNT or metallic SWCNT).

If the nanocarbon is of a semiconductor (semiconducting SWCNT or SWCNT bundle), step b2) is to remove the Sn ions remaining after the sensitization and activation treatments while depositing pure Pd. That is, the reaction Sn²⁺+Pd²⁺═Sn⁴⁺+Pd⁰ is generated on the surface of the semiconducting nanocarbon by the sensitization and activation treatments so that Pd nuclei are formed on the surface while leaving Sn4+. These ions are removed with strong acid.

Step b) includes step b3) in which a nickel plated layer is formed on a surface of the strong acid-treated, oxide-coated nanocarbon by electroless plating in a nickel plating solution.

In step b3), a certain temperature or higher must be maintained to advance auto catalytic plating although the Pd catalyst is activated on the oxide-coated nanocarbon. Further, a higher temperature results in a faster plating reaction.

The nickel plating solution may be suitable for use at an ordinary temperature (operated at 40° C. or less) or at a high temperature (operated at 100° C. or less).

Also, the plating rate may be controlled depending on pH. That is, if the pH of the plating solution is higher than 4.8, the greater the plating rate is.

The coating thickness increases with time, so the plating rate may be controlled according to a required thickness.

In the present invention, step b3) may be preferably performed at 20˜40° C. for 5˜20 min with an ordinary-temperature nickel plate solution or at 70˜100° C. for 1˜10 min with a high-temperature nickel plate solution.

In step b3), the plating solution may be preferably maintained to have a pH of 4 to 6. Within this pH range, the electroless nickel plating solution can be stably maintained, guaranteeing a fast plating rate and high plating efficiency.

When an electroless plating method is used to apply a nickel coating to the oxide-coated nanocarbon, the plated metal can be controlled with regard to loadage, morphology, distribution density, and particle size by adjusting various factors including a Ni—P concentration of the plating solution, deposition time, reaction temperature, a pH of the plating solution, etc.

The plating solution is classified into a high-phosphorus concentration plating solution (phosphorus content: 10˜13%), a middle phosphorus concentration plating solution (phosphorus content: 7˜9%) and a low phosphorus concentration plating solution (phosphorus content: 1˜5%) according to the content of phosphorus. A higher phosphorus content results in a lower plating rate, higher corrosion resistance, and lower thermal resistance.

According to the present invention, the loadage, morphology, distribution density and particle size of Ni—P or Ni can be controlled by controlling process parameters, such as electroless plating solution concentration, deposition time, reaction temperature, pH and the like.

In particular, various shapes of Ni—P coating layers, such as a fibrous Ni—P coating layer, a scale like structure Ni—P coating layer, a spherical Ni—P coating layer and the like, can be formed on the surface of the nanocarbon by controlling process parameters.

A fibrous coating layer may be formed when a reaction rate is slow under the condition of abundant Pd ions, a low temperature and low pH (reference: 4.8).

For a scale-like structure coating layer, a high reaction rate is required, together with abundant Pd ions, a high temperature, a high pH value (reference 4.8).

Further, the formation of a spherical coating layer may be achieved under the conditions of a small amount of Pd ions, a high temperature and a high pH value (reference: 4.8). Given the condition of a low concentration of Pd, serving as a seed in nickel plating, a low temperature, and a high pH, the reaction rapidly proceeds, with the result that nickel ions are collected only on the circumference of Pd, thereby forming a spherical coating layer.

In one embodiment of the present invention, step b) is performed under the conditions of a Pd concentration of 0.4˜1 g/L, a Ni—P concentration of 5˜10 g/L in the nickel plating solution, a deposition time of 10˜15 minutes, a reaction temperature of 70˜80° C. and a pH of 4˜5, so as to form a fibrous nickel plated layer.

For a scale-like structure nickel plated layer, the reaction conditions of step b) include a Pd concentration of 0.4˜1 g/L, a Ni—P concentration of 5˜10 g/L in the nickel plating solution, a deposition time of 5˜10 minutes, a reaction temperature of 80˜100° C., and a pH of 5˜6.

The formation of a spherical nickel plated layer may be achieved by conducting step b) under the conditions of a Pd concentration of 0.12˜50.2 g/L, a Ni—P concentration of 5˜10 g/L in the nickel plating solution, a deposition time of 5˜10 minutes, a reaction temperature of 80˜100° C. and a pH of 5˜6.

In another embodiment of the present invention, copper may be plated in an electroless plating process. In this regard, the oxide-coded nanocarbon is coated with Cu in the presence of a reductant such as formalin (HCHO). For electroless Cu plating, the step b) may comprise b1) immersing the oxide-coated nanocarbon in a Pd solution to form an active Pd nuclei on a surface of the oxide-coated nanocarbon; b2) treating the Pd-nucleated, oxide-coated nanocarbon with strong acid; and b3) depositing a copper layer on the strong acid-treated, oxide-coated nanocarbon by electroless plating in a copper solution.

The steps b1) and b2) are the same as in the electroless nickel plating process. For step b3), first, an electroless copper plating solution is prepared.

For use in electroless plating, the plating solution contains copper sulfate (CuSO₄.5H₂O) as a copper ion source. The electroless copper plating solution may further contain a complexing agent such as EDTA, Rochelle salt (C₄H₄KNaO₆. 4H₂O), Quadrol, or CDTA; a stabilizer such as sodium carbonate; a reductant such as formalin, sodium borohydride, hydrazine, or dimethylamine borane. Formalin is mostly used. In addition, caustic soda such as NaOH, KOH, etc. may be used to supply OH necessary for the oxidation of formalin.

In the present invention, the step b3) may be preferably performed at 30˜70° C. for 5˜20 min while the solution is maintained at a pH of 7 to 12. When an electroless plating method is used to apply a copper coating to the oxide-coated nanocarbon, the plated metal can be controlled with regard to Cu loadage, morphology, distribution density, and particle size by adjusting various factors including a Cu concentration of the plating solution, deposition time, reaction temperature, a pH of the plating solution, etc.

In particular, various shapes of Cu coating layers, such as a fibrous Cu coating layer, a scale like structure Cu coating layer, a spherical Cu coating layer and the like, can be formed on the surface of the nanocarbon by controlling process parameters. At a higher pH and/or a higher temperature, the reaction proceeds more actively. Under the same process parameters, a thicker Cu coating layer is formed with a greater load of Cu.

A fibrous Cu coating layer may be formed when a reaction rate is slow under the condition of abundant Pd ions, a low temperature and high pH (reference: 8).

For a scale-like structure Cu coating layer, a high reaction rate is required, together with abundant Pd ions, a high temperature, a high pH value (reference 8).

Further, the deposition of a spherical coating layer may be achieved under the conditions of a small amount of Pd ions, a high temperature and a high pH value (reference: 8).

In one embodiment of the present invention, step b) is performed under the conditions of a Pd concentration of 0.4˜1 g/L, a Cu concentration of 3˜15 g/L in the copper plating solution, a deposition time of 5˜20 minutes, a reaction temperature of 30˜50° C. and a pH of 7˜9, so as to form a fibrous copper plated layer.

For a scale-like structure copper plated layer, the reaction conditions of step b) include a Pd concentration of 0.4˜1 g/L, a Cu concentration of 3˜15 g/L in the copper plating solution, a deposition time of 5˜20 minutes, a reaction temperature of 50˜70° C., and a pH of 10˜12.

The formation of a spherical copper plated layer may be achieved by conducting step b) under the conditions of a Pd concentration of 0.12˜50.2 g/L, a Cu concentration of 3˜15 g/L in the copper plating solution, a deposition time of 5˜20 minutes, a reaction temperature of 50˜70° C. and a pH of 10˜12.

In step c), the metal and oxide hybrid-coated nanocarbon is thermally treated at 300˜700° C. for 1˜3 hours in an inert gas atmosphere (Ar, N₂, He, etc.), in a vacuum (10⁻³˜10⁻² torr), or in an air atmosphere.

For instance, when nickel is plated, the resulting nickel plated layer formed on the nanocarbon in step b) may be an amorphous Ni—P plated layer. The thermal oxidation converts the amorphous nickel plated layer into a crystalline nickel plated layer.

In another alternative example, when the nanocarbon is coated with copper, the resulting copper coating deposited on the nanocarbon in step b) may be of amorphous structure. This amorphous Cu coating layer can be converted into a crystalline Cu coating layer by thermal oxidation.

Hence, the step b) may be performed in sequential processes of pre-treatment, activation, acceleration, and then plating when the nanocarbon is CNF, MWCNT, TWCNT, DWCNT or metallic SWCNT, or in sequential processes of pre-treatment, sensitization, activation, acceleration, and then plating when the nanocarbon is a semiconducting SWCNT or SWCNT bundle.

In accordance with another aspect thereof, the present invention addresses the metal and oxide hybrid-coated nanocarbon fabricated by the method illustrated above.

The metal and oxide hybrid-coated nanocarbon fabricated by the method of the present invention has an oxide content of 0.1˜20.0 wt % and a metal content of 80˜99.9 wt %.

As described above, the aluminum composite casting alloy containing metal and oxide hybrid-coated nanocarbon as a reinforcement is greatly improved in tensile strength and modulus of elasticity, without a significant loss of elongation, compared to pure aluminum.

A better understanding of the present invention may be obtained through the following examples which are set forth to illustrate, but are not to be construed as limiting the present invention.

### Example 1

### Fabrication of TiO₂—Coated CNT

CNT (Hanwha NanoTech, CM-250) was coated with a TiO2 thin film using a sol-gal process. First, CNT was dispersed in ethanol by ultrasonication, with a weight ratio of 1:180 set between CNT and ethanol. This CNT dispersion was mixed with benzyl alcohol as a coupling agent, and stirred in a reactor, with a weight ratio of 1:10 set between CNT and the coupling agent. In this regard, the inside of the reactor was maintained at 0° C. and purged with an inert gas. Subsequently, ethanol was added to the reactor at a predetermined rate in an amount 20 times the weight of CNT. Separately, titanium (IV) n-butoxide (TNBT) was also added to the reactor at a predetermined rate in an amount 20 times the weight of the CNT. As a result, TiO₂-coated CNT was obtained.

The TiO₂-coated CNT was thermally treated at 300, 400, 500, 600, 700, and 800° C. for 2 hr for each temperature in an O₂ atmosphere or an Ar atmosphere.

### Fabrication of Ni—P- and TiO₂-Coated CNT

The TiO₂-coated CNT was immersed in ethanol, and ultrasonicated for 60 min. Then, the CNT was immersed in a [PdCl₂+HCl+H₂O] solution, and ultransonicated for 60 min. The resulting CNT was again immersed in conc. sulfuric acid, and ultrasonicated for 30 min before immersion in a nickel plating solution containing SX-A, SX-M and H₂O. This plating solution was stirred at 200 rpm at 80° C. for 10 min to afford Ni—P- and TiO₂-coated CNT.

SX-A is a nickel plating solution containing 2.138 M nickel sulfate while SX-M is a reducing solution containing 2.36 M sodium hypophosphite.

The Ni—P- and TiO₂-coated CNT was thermally treated at 500° C. for 2 hrs in an Ar atmosphere.

### Example 2

### Fabrication of Cu- and TiO₂-Coated CNT

The TiO₂-coated CNT fabricated in Example 1 was immersed in ethanol, and ultrasonicated for 60 min. Then, the CNT was immersed in a [PdCl₂+HCl+H20] solution, and ultransonicated for 60 min. The resulting CNT was again immersed in conc. sulfuric acid, and ultrasonicated for 30 min before immersion in a nickel plating solution containing 0.1 M copper sulfate (CuSO₄.5H₂O), 0.5 M Rochelle salt (C₄H₄KNaO₆.4H₂O), 0.5 M sodium carbonate, 1 M NaOH, and 0.5 M formalin (HCHO). This plating solution was stirred at 200 rpm at 50° C. for 15 min to afford Cu- and TiO₂-coated CNT.

The Cu- and TiO₂-coated CNT was thermally treated at 500° C. for 2 hrs in an Ar atmosphere.

As described hitherto, the present invention provides a method for fabricating a metal and oxide hybrid-coated nanocarbon useful for nanocarbon-aluminum composites.

By the method according to the present invention, a metal and oxide hybrid-coated nanocarbon can be easily produced at a high yield.

Being superior in wettability and thermal resistance, the metal and oxide hybrid-coated nanocarbon of the present invention can be used as a reinforcement of aluminum and thus finds applications in various fields including automobile, aerospace, shipbuilding, and machinery industries, and in construction/building materials, sport goods, and equipments for leisure time amusement. Inter alia, when applied to transport means including automobiles and aircrafts, the nanocarbon of the present invention allows for weight reduction and an increase in modulus of elasticity, thereby greatly contributing to an improvement in fuel efficiency, convenience, and stability.

What is claimed is:

1. A method for fabricating metal and oxide hybrid-coated nanocarbon, comprising:
a) coating nanocarbon with an oxide to give oxide-coated nanocarbon;
b) coating the oxide-coated nanocarbon with a metal by electroless plating to give metal and oxide hybrid-coated nanocarbon; and
c) crystallizing the metal and oxide hybrid-coated nanocarbon through thermal treatment at a high temperature.

2. The method of claim 1, wherein the nanocarbon of step a) is CNF (Carbon nano fiber), MWCNT (multi wall carbon nanotube), TWCNT (Thin wall carbon nanotube), DWCNT (double wall carbon nanotube) or SWCNT (single wall carbon nanotube).

3. The method of claim 1, wherein the oxide is TiO₂, SiO₂, or Al₂O₃.

4. The method of claim 1, wherein the nanocarbon is used at a volume ratio of 1:1˜1:20 with the oxide.

5. The method of claim 1, wherein the nanocarbon is used at a weight ratio of 1:1˜1:50 with an oxide.

6. The method of claim 1, wherein the oxide is coated at a thickness of 5˜20 nm.

7. The method of claim 1, further comprising a1) removing impurities from the nanocarbon by washing in a solvent and thermally oxidizing, before the step a).

8. The method of claim 1, further comprising a2) thermally treating the oxide-coated nanocarbon at 300˜800° C. for 30 min to 5 hrs in an O₂ or inert gas atmosphere or in a vacuum (10⁻³˜10⁻² torr), after the step a).

9. The method of claim 1, wherein the metal is nickel (Ni) or copper (Cu).

10. The method of claim 1, wherein the step b) comprises:
b1) immersing the oxide-coated nanocarbon in a Pd solution to form an active Pd nuclei on a surface of the oxide-coated nanocarbon;
b2) treating the Pd-nucleated, oxide-coated nanocarbon with strong acid; and
b3) depositing a nickel layer on the strong acid-treated, oxide-coated nanocarbon by electroless plating in a nickel solution.

11. The method of claim 10, wherein the step b3) is performed at 20˜40° C. for 5˜20 min with an ordinary-temperature nickel plate solution or at 70˜100° C. for 1˜10 min with a high-temperature nickel plate solution.

12. The method of claim 10, wherein the plating solution is maintained to have a pH of 4 to 6 in the step b3).

13. The method of claim 1, wherein the step b) is performed under the conditions of a Pd concentration of 0.4˜1 g/L, a Ni—P concentration of 5˜10 g/L in the nickel plating solution, a deposition time of 10˜15 minutes, a reaction temperature of 70˜80° C. and a pH of 4˜5, so as to form a fibrous nickel plated layer.

14. The method of claim 1, wherein the step b) is performed under the conditions of a Pd concentration of 0.4˜1 g/L, a Ni—P concentration of 5˜10 g/L in the nickel plating solution, a deposition time of 5˜10 minutes, a reaction temperature of 80˜100° C. and a pH of 5˜6, so as to form a scale-like nickel plated layer.

15. The method of claim 1, wherein the step b) is performed under the conditions of a Pd concentration of 0.125˜0.2 g/L, a Ni—P concentration of 5˜10 g/L in the nickel plating solution, a deposition time of 5˜10 minutes, a reaction temperature of 80˜100° C. and a pH of 5˜6, so as to form a spherical nickel plated layer.

16. The method of claim 1, wherein the step b) comprises:
b1) immersing the oxide-coated nanocarbon in a Pd solution to form an active Pd nuclei on a surface of the oxide-coated nanocarbon;
b2) treating the Pd-nucleated, oxide-coated nanocarbon with strong acid; and
b3) depositing a copper layer on the strong acid-treated, oxide-coated nanocarbon by electroless plating in a copper solution.

17. The method of claim 1, wherein the step b) is performed under the conditions of a Pd concentration of 0.4˜1 g/L, a Cu concentration of 3˜15 g/L in the copper plating solution, a deposition time of 5˜20 minutes, a reaction temperature of 30˜50° C. and a pH of 7˜9, so as to form a fibrous copper plated layer.

18. The method of claim 1, wherein the step b) is performed under the conditions of a Pd concentration of 0.4˜1 g/L, a Cu concentration of 3˜15 g/L in the copper plating solution, a deposition time of 5˜20 minutes, a reaction temperature of 50˜70° C. and a pH of 10˜12, so as to form a scale-like copper plated layer.

19. The method of claim 1, wherein the step b) is performed under the conditions of a Pd concentration of 0.12˜50.2 g/L, a Cu concentration of 3˜15 g/L in the copper plating solution, a deposition time of 5˜20 minutes, a reaction temperature of 50˜70° C. and a pH of 10˜12, so as to form a spherical copper plated layer.

20. The method of claim 1, wherein the step c) is carried out by thermally oxidizing the metal and oxide hybrid-coated nanocarbon at 300˜700° C. for 1˜3 hours in an inert gas atmosphere, in a vacuum (10⁻³˜10⁻² torr), or in an air atmosphere.

21. A metal and oxide hybrid-coated nanocarbon, fabricated using the method of claim 1.

22. The metal and oxide hybrid-coated nanocarbon of claim 21, containing an oxide content of 0.1˜20.0 weight %, and a metal content of 80˜99.9 weight %.
